(19) United States
(12) Patent Application Publication
(10) Pub. No.: US 2026/0312909 A1
(43) Pub. Date: Oct. 8, 2026

(54) A METHOD OF REPORTING APPLICATION DETECTION INFORMATION BY A USER PLANE FUNCTION, UPF, IN A SERVICE BASED ARCHITECTURE, SBA, TELECOMMUNICATION NETWORK.

(71) Applicant: Telefonaktiebolaget LM Ericsson (publ), Stockholm (SE)

(72) Inventor: Miguel Angel MUÑOZ DE LA TORRE ALONSO, Madrid (ES)

(21) Appl. No.: 19/480,962

(22) PCT Filed: May 3, 2024
(86) PCT No.: PCT/EP2024/062181

§ 371 Date: Nov. 3, 2025

(30) Foreign Application Priority Data
May 4, 2023 (EP) 23382412.7

(51) Int. Cl. H04L 47/2475; H04W 28/02; H04W 76/10

(52) U.S. Cl. CPC H04L 47/2475; H04W 28/0215; H04W 76/10

(57) ABSTRACT

A method of reporting application detection information by a User Plane Function, UPF, in a Service Based Architecture, SBA, telecommunication network, wherein the method includes receiving, by the UPF, from a User Equipment, UE, a packet associated with application traffic, detecting, by the UPF, the application traffic, determining, by the UPF, that application detection information is to be reported by recognizing the occurrence of a value of one particular field in a certain protocol stack header of the packet different from previous values of the particular field in the certain protocol stack header of any packet received from the UE, the one particular field being comprised by the packet and reporting, by the UPF, to a Session Management Function, SMF, the application detection information based on the determination that the application detection information is to be reported.

### TECHNICAL FIELD

The present disclosure is related to application reporting and, more specifically, to mechanisms by which Network Functions, NFs, are able to report various aspects of the behaviour and performance of applications used by User Equipment, UE, to the core network.

### BACKGROUND

Application Reporting is a process in the telecommunications industry that enables the collection and analysis of data involving various network elements, such as the Service Management Function, SMF, User Plane Function, UPF, Policy Control Function, PCF, User Equipment, and applications.

In the context of 3GPP TS 29.244, Application Reporting is a standardized mechanism that allows network operators to monitor the performance of different applications, such as cloud-based gaming, video streaming, web browsing, and file downloads, in real-time. The protocol specifies the format and structure of the data that is collected and the procedures for reporting and analysing this data.

For example, when detecting the start or stop of an application, the User Plane Function, UPF, may initiate a PFCP Session Report procedure and send a Usage Report with the Usage Report Trigger set to ‘Start of Traffic’ or ‘Stop of Traffic’. The UPF may also include the following information in the Usage Report:

When reporting the start of an application: the Application ID; the Flow Information including the Flow Description and the Flow Direction, if the traffic flow information is deducible; the Application-Instance-Identifier, if the traffic flow information is deducible; and if no UE IP address was provisioned in the PDI, the UE's IP address, and the Network instance when multiple PDNs with overlapping IP addresses are used in the UP function.

When reporting the stop of an application: the Application ID; the application-Instance-Identifier, if an Application Identifier was provided when reporting the start of the application; if no UE IP address was provisioned in the PDI, the UE's IP address, and the Network instance when multiple PDNs with overlapping IP addresses are used in the UP function.

The SMF is responsible for managing the user's data and signaling traffic in the 5G core network. The SMF can collect application-related data from the UPF and forward it to the PCF for policy enforcement. The UPF is responsible for routing and forwarding user data packets to and from the user equipment and the data network. The UPF can also collect data related to user traffic and application performance and report it to the SMF.

The PCF is responsible for enforcing policies related to Quality of Service, QoS, and charging in the 5G core network. The PCF receives application-related data from the SMF and UPF and uses it to make decisions regarding QoS and charging. The PCF can also use this data to optimize network resources and improve the user experience.

One of the downsides of application reporting, as mentioned above, is that the mechanisms that are in place may not be adequate anymore for the trends recognized in the network, such as cloud gaming, media streaming and extended reality applications.

### SUMMARY

It is an object of the present disclosure to provide for a mechanism that allows the network operator to improve the reporting of application detection information. It would therefore be advantageous to obtain methods of reporting application detection information by a User Plane Function, UPF, as well as related methods for the Session Management Function, SMF, and Policy Control Function, PCF. It would further be advantageous to obtain corresponding network functions, NFs.

In a first aspect of the present disclosure, there is provided a method of reporting application detection information by a User Plane Function, UPF, in a Service Based Architecture, SBA, telecommunication network, wherein said method comprises the steps of:
receiving, by said UPF, from a User Equipment, UE, a packet associated with application traffic;
detecting, by said UPF, said application traffic;
determining, by said UPF, that application detection information is to be reported by recognizing the occurrence of a value of one particular field in a certain protocol stack header of said packet different from previous values of said particular field in said certain protocol stack header of any packet received from said UE, said one particular field being comprised by said packet;
reporting, by said UPF, to a Session Management Function, SMF, said application detection information based on said determination that said application detection information is to be reported.

The inventor has found that it may be beneficial to use the occurrence of a value of one particular field in a certain protocol stack header of the packet to determine that application detection information is to be reported. More specifically, the occurrence of a value of one particular field in a certain protocol stack head of the packet different being different from previous values of the particular field in the certain protocol stack head of any packet received from the UE.

For example, the UPF, when detecting traffic for the application, may store the flow information, for example a 5-tuple, and may report to the SMF the application detection information including only the server Internet Protocol, IP, address, not the whole 5-tuple. As such, if there are multiple flows towards a certain server IP address, only a single report will be triggered.

In summary, the UPF may check each new 5-tuple and compare if the destination IP address, i.e. the server IP address, is the same as the one previously reported. If that is the case, then the application detection information is reported to the SMF.

It is noted that the above described example focuses on the server IP address, i.e. information flows are aggregated based on traffic going to a certain server IP address. However, the present disclosure is also applicable to other semantics, i.e. by aggregating on other elements of the 5-tuple or even any other field in the packet, for example fields in the header of the packet like DSCP code or ECN bits.

In an example, said method comprises the step of:

receiving, by said UPF, a subscription to reporting application detection information, wherein said subscription indicates to said UPF that application detection information is to be reported by recognizing the occurrence of said value of said particular field in said certain protocol stack header of said packet different from previous values of said particular field in said protocol stack header of any packet received from said UE.

The inventor has found that it might be beneficial to distinguish multiple use cases. The first use case is directed to the traditional way of reporting application detection information, as highlighted in the background section of the present disclosure. The second use case may be directed to a subscription. The SMF may subscribe to the UPF on application start and stop events and may include an indication to enable the improved reporting of application detection information.

The subscription thus indicates to the UPF that application detection information is to be reported on the occurrence of a new server IP address, or anything alike.

In an example, the one particular field is any of:
a server address;
a Differentiated Services Code Point, DSCP, field comprised by a header of said IP packet;
Explicit Congestion Notification, ECN, bits comprised by a header of said IP packet;
a field in any of the QUIC header or TCP header.

The server address may, for example, be an Internet Protocol, IP, address or a domain name or anything alike.

The Differentiated Services Code Point, DSCP, field is a field in the header of an Internet Protocol, IP, packet that is used to indicate the level of service or priority that should be given to the packet as it is transmitted through the network. The DSCP field is used by network devices to determine how to handle the packet as it is forwarded through the network. Different DSCP values are assigned to packets based on their type, such as voice traffic or video traffic, and these values are used to prioritize traffic and ensure that critical traffic is transmitted with minimal delay and loss.

The Explicit Congestion Notification, ECN, is a field in the header of an Internet Protocol, IP, packet that is used to notify network devices about congestion in the network. The ECN field typically contains two bits that are used to indicate the level of congestion experienced by the packet as it is transmitted through the network. When a network device encounters congestion, it can set the ECN bits to notify other devices that congestion is present. This allows devices to respond proactively to the congestion by reducing their traffic load and helping to prevent further congestion in the network. The use of ECN helps to improve network performance and reduce packet loss, which can improve the overall quality of service for User Equipment in the network.

QUIC, Quick UDP Internet Connections, is a transport layer protocol designed to provide fast, secure, and reliable communication over the Internet. The QUIC protocol uses a header format that is optimized for performance and includes several fields to ensure reliable delivery of data.

The QUIC header consists of several fields, including: Connection ID: A unique identifier for the connection between the client and the server.

Packet Number: A sequence number that is used to ensure reliable delivery of packets.

Flags: A set of flags that indicate the purpose of the packet, such as whether it contains data or is a control packet.

Version: The version of the QUIC protocol being used.

Payload: The data being transmitted in the packet.

The use of QUIC may have several benefits, including reduced latency, improved security, and the ability to recover quickly from packet loss.

In a further example, the step of detecting said application traffic is based on per flow detection.

In another example, the step of detecting comprises detecting a 5-tuple comprising source address, source port, destination address, destination port and protocol.

In the context of flow detection at the User Plane Function, UPF, 5-tuple refers to a set of five values that are used to identify a specific data flow between two endpoints. These values include:

Source IP address: The IP address of the sender of the data packets.

Destination IP address: The IP address of the receiver of the data packets.

Source port number: The port number being used by the sender.

Destination port number: The port number being used by the receiver.

Protocol: The transport protocol being used, such as TCP, UDP, or ICMP.

Together, these five values make up the 5-tuple that is used to uniquely identify a data flow. The UPF uses the 5-tuple to classify and manage data flows, allowing it to apply policies and quality-of-service, QoS, rules to specific flows based on their characteristics. By using the 5-tuple, the UPF can ensure that each data flow is treated appropriately and efficiently, improving network performance and providing a better user experience.

As mentioned above, the present disclosure may be directed to reporting of application information based on a new occurrence of the server (destination) IP address in the 5-tuple. Not based on each 5-tuple as such.

The application detection information may then comprise that particular field, i.e. the server IP address, and may exclude the 5-tuple as such. This allows the recipient to identify the trigger for reporting the application information, i.e. the server IP address.

In yet another example, the method comprises the step of:
receiving, by said UPF, from said SMF, an Information Element, IE, associated with said application detection information, wherein said IE indicates that said application detection information is to comprise said particular field and is to exclude said 5-tuple.

In a further example, the method comprises the step of:
maintaining, by said UPF, encountered values of said particular field.

This allows the UPF to efficiently know whether a value of the particular field has occurred before, or not. If a new value is identified, that may form the trigger for reporting the application information.

In a further example, the step of maintaining comprises associating a time stamp for each of said encountered values, wherein said method comprises the step of:
disregarding, by said UPF, an encountered value of said particular field when a timer, from said associated time stamp, has exceeded a predefined time period.

The inventor has found that it might be beneficial to introduce a time out value for assessing whether a received value for a particular field may be considered a new value or not. The time out value may be set of preferences by the network operator, or may be set based on predefined criteria, or the like.

In a second aspect of the present disclosure, there is provided a method of supporting reporting application detection information by a Session Management Function, SMF, in a Service Based Architecture, SBA, telecommunication network, wherein said method comprises the steps of:
subscribing, by a Session Management Function, SMF, comprised by said SBA telecommunication network, to a User Plane Function, UPF, to reporting application detection information, wherein said subscribing indicates to said UPF that application detection information is to be reported by recognizing the occurrence of a value of a particular field in said certain protocol stack header of a packet different from previous values of said particular field in said protocol stack header of any packet received from said UE, said one particular field being comprised by a packet that is received by said UPF from a User Equipment, UE.

It is noted that the advantageous as explained with respect to the first aspect of the present disclosure, being the method performed by the UPF, are also applicable to the second aspect of the present disclosure, being the method performed by the SMF.

The second aspect is related to the subscription mechanism, wherein the SMF subscribes to the UPF for providing the differentiated service in the application detection reporting. That is, the SMF subscribes to the UPF on application start and stop events and includes an indication to enable improved reporting of application detection information, i.e. not based on each 5-tuple but based on one particular field for example the server IP address of the 5-tuple. The result is that if there are multiple flows towards a certain server IP address, only a single report will be triggered by the UPF.

In an example, the UPF is to detect a 5-tuple comprising source address, source port, destination address, destination port and protocol wherein said method comprises the step of:
transmitting, by said SMF, to said UPF, an Information Element, IE, associated with said application detection information, wherein said IE indicates that said application detection information is to comprise said particular information element and is to exclude said detected 5-tuple.

In a further example, the method comprises the step of:
receiving, by said SMF, from said UPF a Policy and Charging Control, PCC, rule with Service Data Flow, SDF, filter comprising only the particular information element.

In yet another example, the step of subscribing is implemented in a Packet Forwarding Control Protocol, PFCP, Session Establishment Request message.

In another example, the one particular field is any of:
a server address;
a Differentiated Services Code Point, DSCP, field comprised by a header of said IP packet;
Explicit Congestion Notification, ECN, bits comprised by a header of said IP packet;
a field in any of the QUIC header or TCP header.

In a third aspect of the present disclosure, there is provided a method of supporting reporting application detection information by a Policy Control Function, PCF, in a Service Based Architecture, SBA, telecommunication network, wherein said method comprises the steps of:
retrieving, by said PCF, from a subscriber database, subscriber data associated with a User Equipment, UE, of said SBA telecommunication network;
determining, by said PCF, based on said subscriber data, that Quality of Service, QoS, differentiation is required for an application;
subscribing, by said PCF, to said SMF, to reporting application detection information, wherein said subscribing indicates to said SMF that application detection information is to be reported by recognizing the occurrence of a value of a particular field in a certain protocol stack header of a packet different from previous values of said particular field in said protocol stack header of any packet received from said UE, said one particular field being comprised by a packet that is received by said UPF from a User Equipment, UE.

It is noted that the advantages as explained with respect to the first and second aspect of the present disclosure, being the methods performed by the UPF and the SMF, respectively, are also applicable to the third aspect of the present disclosure, being the method performed by the PCF.

In another aspect of the present disclosure, there is provided a User Plane Function, UPF, arranged for reporting application detection information in a Service Based Architecture, SBA, telecommunication network, wherein said UPF comprises:
receive equipment arranged for receiving from a User Equipment, UE, an Internet Protocol, IP, packet directed associated with application traffic;
detect equipment arranged for detecting said application traffic;
process equipment arranged for determining that application detection information is to be reported by recognizing the occurrence of a value of one particular field in a certain protocol stack header of said packet different from previous values of said particular field in said certain protocol stack header of any packet received from said UE, said one particular information element being comprised by said packet;
report equipment arranged for reporting to a Session Management Function, SMF, said application detection information based on said determination that said application detection information is to be reported.

In an example, the receive equipment is further arranged for receiving a subscription to reporting application detection information, wherein said subscription indicates to said UPF that application detection information is to be reported by recognizing the occurrence of said value of said particular field in said certain protocol stack header of said packet different from previous values of said particular field in said protocol stack header of any packet received from said UE.

In a further example, the one particular field is any of:
a destination address;
a Differentiated Services Code Point, DSCP, field comprised by a header of said IP packet;
Explicit Congestion Notification, ECN, bits comprised by a header of said IP packet;
a field in any of the QUIC header or TCP header.

In an example, the detect equipment is further arranged for detecting said application traffic based on per flow detection.

In a further example, the detect equipment is further arranged for detecting a 5-tuple comprising source address, source port, destination address, destination port and protocol.

In yet another example, the application detection information comprises said particular information element and excludes said 5-tuple.

In a further example, the receive equipment is further arranged for receiving, from said SMF, an Information Element, IE, associated with said application detection information, wherein said IE indicates that said application detection information is to comprise said particular field and is to exclude said 5-tuple.

In an example, the UPF further comprises:
install equipment arranged for installing, towards said SMF a Policy and Charging Control, PCC, rule with Service Data Flow, SDF, filter comprising only the particular field.

In an example, the UPF further comprises:
maintain equipment arranged for maintaining encountered values of said particular field.

In an even further example, the maintain equipment is further arranged for associating a time stamp for each of said encountered values, wherein said maintain equipment is further arranged for disregarding an encountered value of said particular information element when a timer, from said associated time stamp, has exceeded a predefined time period.

In a further aspect of the present disclosure, there is provided a Session Management Function, SMF, arranged for supporting reporting application detection information by a User Plane, UPF, in a Service Based Architecture, SBA, telecommunication network, wherein SMF comprises:
subscribe equipment arrange for subscribing, to a User Plane Function, UPF, to reporting application detection information, wherein said subscribing indicates to said UPF that application detection information is to be reported by recognizing the occurrence of a value of a particular field in said certain protocol stack header of a packet different from previous values of said particular field in said protocol stack header of any packet received from said UE, said one particular field being comprised by a packet that is received by said UPF from a User Equipment, UE.

In an example, the UPF is to detect a 5-tuple comprising source address, source port, destination address, destination port and protocol wherein said SMF comprises:
transmit equipment arranged for transmitting, to said UPF, an Information Element, IE, associated with said application detection information, wherein said IE indicates that said application detection information is to comprise said particular field and is to exclude said detected 5-tuple.

In a further example, the SMF comprises:
receive equipment arranged for receiving, from said UPF, a Policy and Charging Control, PCC, rule with Service Data Flow, SDF, filter comprising only the particular field.

In yet another example, the subscribe equipment is arranged to implement said subscribing in a Packet Forwarding Control Protocol, PFCP, Session Establishment Request message.

In a further example, the one particular field is any of:
a destination address;
a Differentiated Services Code Point, DSCP, field comprised by a header of said IP packet;
Explicit Congestion Notification, ECN, bits comprised by a header of said IP packet;
a field in any of the QUIC header or TCP header.

In a further aspect of the present disclosure, there is provided a Policy Control Function, PCF, arranged to operate in a Service Based Architecture, SBA, telecommunication network, wherein said PCF comprises:
retrieve equipment arranged for retrieving, from a subscriber database, subscriber data associated with a User Equipment, UE, of said SBA telecommunication network;
process equipment arranged for determining, based on said subscriber data, that Quality of Service, QoS, differentiation is required for an application;
subscribe equipment arranged for subscribing, to a Session Management Function, SMF, to reporting application detection information, wherein said subscribing indicates to said SMF that application detection information is to be reported by recognizing the occurrence of a value of a particular field in a certain protocol stack header of a packet different from previous values of said particular field in said protocol stack header of any packet received from said UE, said one particular field being comprised by a packet that is received by said UPF from a User Equipment, UE.

In yet another aspect, there is provided a computer program product comprising a computer readable medium having instructions stored thereon which, when executed by a Network Function, NF, of a Service Based Architecture, SBA, telecommunication network, cause said NF to implement a method in accordance with any of the previous examples.

The present disclosure is described in conjunction with the appended figures. It is emphasized that, in accordance with the standard practice in the industry, various features are not drawn to scale. In fact, the dimensions of the various features may be arbitrarily increased or reduced for clarity of discussion.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

The above and other aspects of the disclosure will be apparent from and elucidated with reference to the examples described hereinafter.

### BRIEF DESCRIPTION OF THE DRAWINGS

FIG. 1 discloses a flow chart of a PDU session establishment of a UE in accordance with the present disclosure;

FIG. 2 discloses a flow chart of a UE initiating application traffic in accordance with the present disclosure;

FIG. 3 discloses a further flow chart of a UE initiating application traffic in accordance with the present disclosure;

FIG. 4 discloses another flow chart of a UE initiating application traffic in accordance with the present disclosure;

FIG. 5 discloses a schematic block diagram of a User Plane Function in accordance with the present disclosure;

FIG. 6 discloses a schematic block diagram of a Session Management Function in accordance with the present disclosure;

FIG. 7 discloses a schematic block diagram of a Policy Control Function in accordance with the present disclosure.

### DETAILED DESCRIPTION

It is noted that in the description of the figures, same reference numerals refer to the same or similar components performing a same or essentially similar function.

A more detailed description is made with reference to particular examples, some of which are illustrated in the appended drawings, such that the manner in which the features of the present disclosure may be understood in more detail. It is noted that the drawings only illustrate typical examples and are therefore not to be considered to limit the scope of the subject matter of the claims. The drawings are incorporated for facilitating an understanding of the disclosure and are thus not necessarily drawn to scale. Advantages of the subject matter as claimed will become apparent to those skilled in the art upon reading the description in conjunction with the accompanying drawings.

The ensuing description above provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment of the disclosure, it being understood that various changes may be made in the function and arrangement of elements, including combinations of features from different embodiments, without departing from the scope of the disclosure.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, electromagnetic, or a combination thereof. Additionally, the words “herein,” “above,” “below,” and words of similar import, when used in this application, refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list.

These and other changes can be made to the technology in light of the following detailed description. While the description describes certain examples of the technology, and describes the best mode contemplated, no matter how detailed the description appears, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the Detailed Description section explicitly defines such terms. Accordingly, the actual scope of the technology encompasses not only the disclosed examples, but also all equivalent ways of practicing or implementing the technology under the claims.

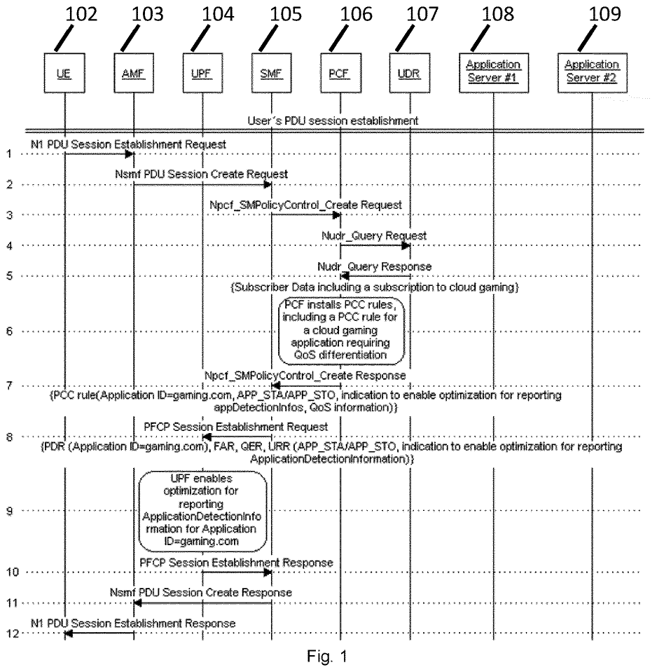

FIG. 1 discloses a flow chart of a PDU session establishment of a UE in accordance with the present disclosure.

The Service Based Architecture that is shown is directed to a 5G network. It is noted that other types of Service Based Architectures may also be applicable to the present disclosure.

The network comprises a User Equipment, UE, 102, an Access and Mobility Function, AMF, 103, a User Plane Function, UPF, 104, a Session Management Function, SMF, 105, a Policy Control Function, PCF, 106 a User Data Repository, UDR, 107, a first Application Server, AS #1, 108 and a second Application Server, AS #2, 109.

FIGS. 1-4 show flow charts in accordance with the present disclosure, for an example Use Case of a user subscribed to cloud gaming, where the gaming application is simplified as consisting of four flows and two server IP addresses, as in real cloud applications there are much more flows, and focused on start reporting, not showing stop reporting. Steps are detailed below:

Steps 1 to 3 are related to the PDU Session Establishment procedure and are not elaborated in detail in this particular disclosure.

In steps 4 and 5, the PCF retrieves from the UDR the subscriber data for UE-ID, specifically a subscription to cloud gaming.

In steps 6 and 7, based on the above identified information received from the UDR, i.e. user subscribed to cloud gaming, which requires QoS differentiation for cloud gaming applications, the PCF installs PCC rules, specifically a PCC rule for Application ID, e.g. gaming.com, for which PCF subscribes to SMF on application start and stop events including an indication to enable improved reporting application detection information, and the associated QoS information.

The indication thus indicates that the reporting should be performed based on a newly identified value for a particular field in a packet, not for every packet as such.

In step 8, the SMF triggers the PFCP Session Establishment procedure towards the UPF to indicate the Packet Detection Rules, PDRs, and the corresponding enforcement action, i.e. FARs, QERs, URRs, etc, for the PDU session. Specifically, a PDR, i.e. Application ID=gaming.com, associated to a URR including the subscription to the application start and stop events, i.e. APP_STA/APP_STO, and an indication to enable improved reporting application detection information. Specifically, it is proposed in the present disclosure to define a new flag in the Measurement Information IE in the Create/Update URR IE, as shown in 3GPP TS 29.244 table provided below.

| | | | | | | | | |
|---|---|---|---|---|---|---|---|---|
| M\|easurement | C | This IE shall be included if any of the following flag is set | | | | | | Measurement |
| Information | | to “1”. | | | | | | Information |
| | | Applicable flags are: | | | | | | |
| | | Measurement Before QoS Enforcement Flag: this | — | X | X | X | — | |
| | | flag shall be set to “1” if the traffic usage before | | | | | | |
| | | any QoS Enforcement is requested to be | | | | | | |
| | | measured. | | | | | | |
| | | Inactive Measurement Flag: this flag shall be set | — | X | — | X | — | |
| | | to “1” if the measurement shall be paused | | | | | | |
| | | (inactive). The measurement shall be performed | | | | | | |
| | | (active) if the bit is set to “0” or if the Measurement | | | | | | |
| | | Information IE is not present in the Create URR IE. | | | | | | |
| | | Reduced Application Detection Information Flag: | — | X | — | X | — | |
| | | this flag may be set to “1”, if the Reporting | | | | | | |
| | | Triggers request to report the start or stop of | | | | | | |
| | | application, to request the UP function to only | | | | | | |
| | | report the Application ID in the Application | | | | | | |
| | | Detection Information, e.g. for envelope reporting. | | | | | | |
| | | Immediate Start Time Metering Flag: this flag may | — | X | X | X | — | |
| | | be set to “1” if time-based measurement is used | | | | | | |
| | | and the UP function is requested to start the time | | | | | | |
| | | metering immediately at receiving the flag.. | | | | | | |
| | | Measurement of Number of Packets Flag: this flag | X | X | X | X | — | |
| | | may be set to “1” when the Volume-based | | | | | | |
| | | measurement applies, to request the UP function | | | | | | |
| | | to report the number of packets in UL/DL/Total in | | | | | | |
| | | addition to the measurement in octet. | | | | | | |
| | | Send Start Pause of Charging Flag: this flag may | X | — | — | X | — | |
| | | be set to “1” by the CP function if the UP Function | | | | | | |
| | | is requested to send a Start Pause of Charging | | | | | | |
| | | indication to the upstream GTP-U entity(s) when | | | | | | |
| | | the Dropped DL Traffic Threshold is reached. | | | | | | |
| | | Applicable for Start of Pause of Charging Flag: | — | X | — | X | — | |
| | | this flag may be set to “1” if the URR is applicable | | | | | | |
| | | for Start of Pause of Charging, so that the UP | | | | | | |
| | | function shall stop the usage measurement for the | | | | | | |
| | | URR when receiving Start Pause of Charging | | | | | | |
| | | indication from the peer downstream GTP-U | | | | | | |
| | | entity. | | | | | | |
| | | Control of Inactive Measurement Flag: the flag | — | X | — | X | — | |
| | | shall be set to “1” if the CP function requests the | | | | | | |
| | | UP function to stop or resume the usage | | | | | | |
| | | measurement for the URR with the “ASPOC” flag | | | | | | |
| | | set to “1” according to the value of Inactive | | | | | | |
| | | Measurement Flag. | | | | | | |
| | | Optimized Application Detection Information | — | X | — | X | — | |
| | | Flag: this flag may be set to “1”, if the | | | | | | |
| | | Reporting Triggers request to report the start | | | | | | |
| | | or stop of application, to request the UP | | | | | | |
| | | function to only report each occurrence of the | | | | | | |
| | | Server IP address in the Flow Information in | | | | | | |
| | | the Application Detection Information. | | | | | | |

As mentioned above, the present disclosure can be generalized to other semantics of the application instance, e.g. instead of aggregating per server IP address, by aggregating on other elements of the 5-tuple or even any other fields in the packet, e.g. fields in the IP packet header like DSCP code or ECN bits. This may require defining extra bits.

In step 9, based on the information received in Step 8 above, UPF enables improved reporting ApplicationDetectionInformation for Application ID=gaming.com.

In step 10, the UPF answers the message in Step 8 with a PFCP Session Establishment response message indicating successful operation.

In step 11, the SMF answers the message in Step 2 indicating successful operation and in step 12, the AMF answers the message in Step 1 indicating successful operation.

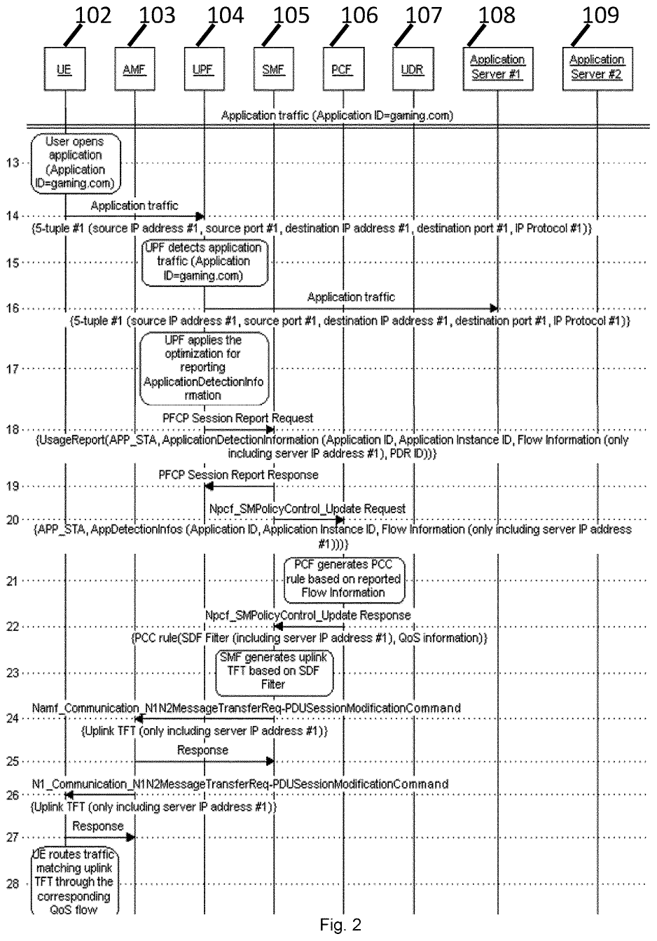

FIG. 2 discloses a flow chart of a UE initiating application traffic in accordance with the present disclosure.

In steps 13 and 14, the User opens an application, i.e. Application ID=gaming.com. The UE triggers multiple flows, in this example, for simplicity, four flows, two of them for each of two application servers. The first flow (5-tuple #1) includes the 5-tuple parameters:
source IP address #1
source port #1
destination IP address #1
destination port #1.
IP Protocol #1

In steps 15 and 16, the UPF detects application traffic, i.e. Application ID=gaming.com, and forwards it towards the Application Server #1.

In steps 17 and 18, the UPF applies the improved reporting ApplicationDetectionInformation, which may imply storing only the destination IP address #1 and reporting it by triggering a PFCP Session Report Request message including a Usage Report with the following information:
APP_STA
ApplicationDetectionInformation, including:
Application ID.
Application Instance ID. In the proposed optimized reporting procedure, an application instance is all the application traffic going to a certain server.
Flow Information (only including server IP address #1).
PDR ID

In step 19, the SMF answers the message in Step 18 indicating successful operation.

In step 20, the SMF forwards the application start event to PCF by triggering a Npcf_SMPolicyControl_Update Request message including the following information:
APP_STA.
AppDetectionInfos, including:
Application ID.
Application Instance ID. In the proposed optimized reporting procedure, an application instance is all the application traffic going to a certain server.
Flow Information (only including server IP address #1).

In steps 21 and 22, the PCF generates a PCC rule based on the reported Flow Information in Step 20 above and triggers a Npcf_SMPolicyControl_Update Response message including the following information:
PCC rule, including:
SDF Filter set to server IP address #1.
QoS information

In step 23, the SMF generates an uplink TFT based on the SDF Filter in the PCC rule received above.

In step 24, the SMF forwards to the UE, through AMF the UL TFT by triggering a Namf_Communication_N1N2Message TransferReq-PDUSessionModificationCommand message including the following information:
Uplink TFT (only including server IP address #1).

In step 25, the AMF answers the message in step 24 indicating successful operation.

In step 26, the AMF forwards transparently to UE the UL TFT by triggering a N1_Communication_N1N2Message TransferReq-PDUSessionModificationCommand message including the following information:
Uplink TFT (only including server IP address #1).

In step 27, the UE answers the message in Step 26 indicating successful operation and in step 28, the UE routes traffic matching uplink TFT through the corresponding QoS flow.

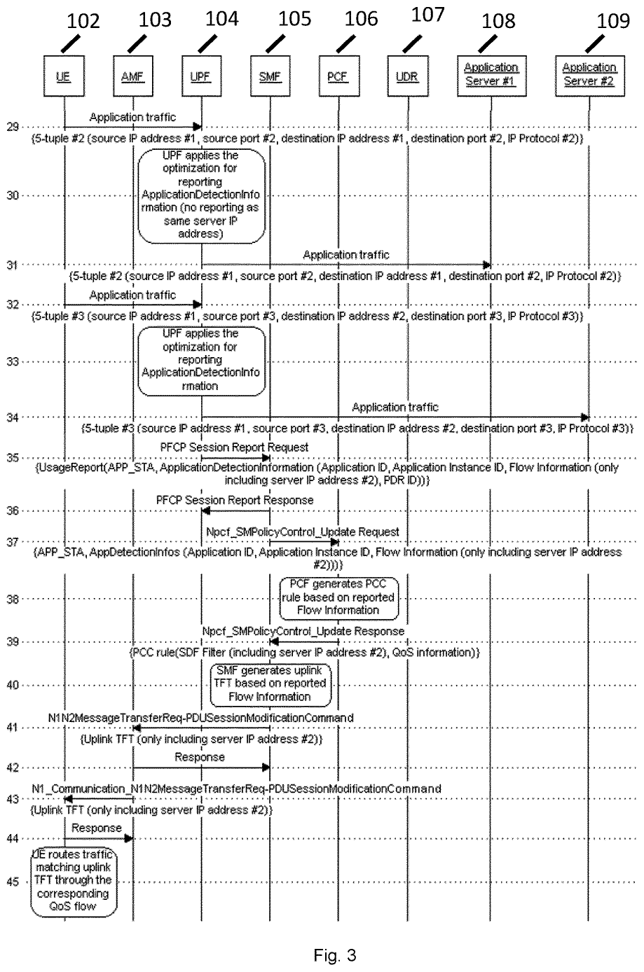

FIG. 3 discloses a further flow chart of a UE initiating application traffic in accordance with the present disclosure.

In step 29, as part of application traffic, i.e. gaming.com, the UE triggers a second flow. This second flow (5-tuple #2) includes the 5-tuple parameters:
source IP address #1
source port #2
destination IP address #1 (this second flow goes to the same server IP address as the first flow)
destination port #2
IP Protocol #2

In steps 30 and 31, the UPF detects application traffic (Application ID=gaming.com) and forwards it towards the Application Server #1. UPF applies the optimization for reporting ApplicationDetectionInformation (no reporting as same server IP address as the one already reported).

In step 32, the UE triggers another flow. The third flow (5-tuple #3) includes the 5-tuple parameters:
source IP address #1
source port #3
destination IP address #2 (new server IP address)
destination port #2.
IP Protocol #2

In steps 33 to 35, the UPF detects application traffic (Application ID=gaming.com) and forwards it towards the Application Server #2. UPF applies the optimization for reporting ApplicationDetectionInformation, which implies storing (new) only the destination IP address #2 and reporting it by triggering a PFCP Session Report Request message including a Usage Report with the following information:
APP_STA
ApplicationDetectionInformation, including:
Application ID
Application Instance ID. In the proposed optimized reporting procedure, an application instance is all the application traffic going to a certain server.
Flow Information (only including server IP address #2).
PDR ID
   Step 36) SMF answers the message in Step 35 indicating successful operation.
   Step 37) SMF forwards the application start event to PCF by triggering a Npcf_SMPolicyControl_Update Request message including the following information:
APP_STA
AppDetectionInfos, including:
Application ID.
Application Instance ID. In the proposed optimized reporting procedure, an application instance is all the application traffic going to a certain server.
Flow Information (only including server IP address #2).

In steps 38 and 39, the PCF generates a PCC rule based on the reported Flow Information in Step 37 above and triggers a Npcf_SMPolicyControl_Update Response message including the following information:
PCC rule, including:
SDF Filter set to server IP address #2.
QoS information

In step 40, the SMF generates an uplink TFT based on the SDF Filter in the PCC rule received above.

In step 41, the SMF forwards to UE (through AMF) the UL TFT by triggering a Namf_Communication_N1N2Message TransferReq-PDUSessionModificationCommand message including the following information:
Uplink TFT (only including server IP address #2).

In step 42, the AMF answers the message in step 41 indicating successful operation.

In step 43, the AMF forwards transparently to UE the UL TFT by triggering a N1_Communication_N1N2Message TransferReq-PDUSessionModificationCommand message including the following information:
Uplink TFT (only including server IP address #2).

In step 44, the UE answers the message in step 43 indicating successful operation and in step 45, the UE routes traffic matching uplink TFT through the corresponding QoS flow.

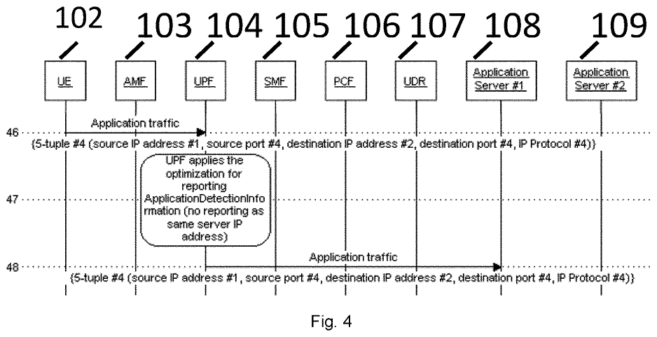

FIG. 4 discloses another flow chart of a UE initiating application traffic in accordance with the present disclosure.

In step 46, as part of application traffic (gaming.com), UE triggers a fourth flow. This second flow (5-tuple #4) includes the 5-tuple parameters:
source IP address #1
source port #4
destination IP address #2 (this second flow goes to the same server IP address as the first flow)
destination port #4
IP Protocol #4

In steps 47 and 48, the UPF detects application traffic (Application ID=gaming.com) and forwards it towards the Application Server #2. UPF applies the optimization for reporting ApplicationDetectionInformation (no reporting as same server IP address as the one already reported).

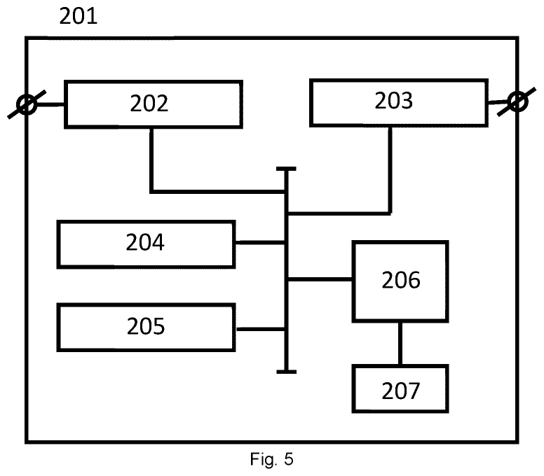

FIG. 5 discloses a schematic block diagram of a User Plane Function in accordance with the present disclosure.

The User Plane Function, UPF, 201 is arranged for reporting application detection information in a Service Based Architecture, SBA, telecommunication network, wherein said UPF comprises:
receive equipment 204 arranged for receiving, via receive terminal 202, from a User Equipment, UE, an Internet Protocol, IP, packet directed associated with application traffic;
detect equipment 204 arranged for detecting said application traffic;
process equipment 206 arranged for determining, using memory 207, that application detection information is to be reported by recognizing the occurrence of a value of one particular field in a certain protocol stack header of said packet different from previous values of said particular field in said certain protocol stack header of any packet received from said UE, said one particular information element being comprised by said packet;
report equipment 205 arranged for reporting, via transmit terminal 203, to a Session Management Function, SMF, said application detection information based on said determination that said application detection information is to be reported.

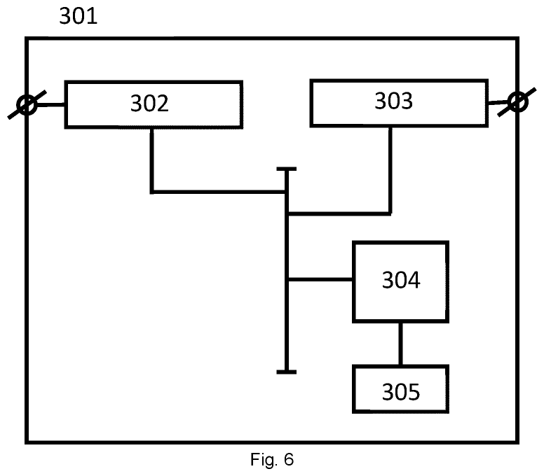

FIG. 6 discloses a schematic block diagram of a Session Management Function in accordance with the present disclosure.

The Session Management Function, SMF, 301 is arranged for supporting reporting application detection information by a User Plane, UPF, in a Service Based Architecture, SBA, telecommunication network, wherein SMF comprises:
subscribe equipment 304 arrange for subscribing, using a memory 305, to a User Plane Function, UPF, to reporting application detection information, wherein said subscribing indicates to said UPF that application detection information is to be reported by recognizing the occurrence of a value of a particular field in said certain protocol stack header of a packet different from previous values of said particular field in said protocol stack header of any packet received from said UE, said one particular field being comprised by a packet that is received by said UPF from a User Equipment, UE. Incoming and outgoing packets are processed via the receive and transmit terminals 302, 303, respectively.

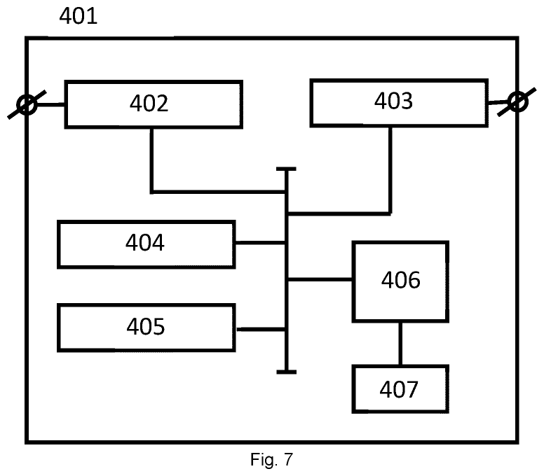

FIG. 7 discloses a schematic block diagram of a Policy Control Function in accordance with the present disclosure.

The Policy Control Function, PCF, 401 is arranged to operate in a Service Based Architecture, SBA, telecommunication network, wherein said PCF comprises:
retrieve equipment 404 arranged for retrieving, via the receive terminal 402 and the transmit terminal 403, from a subscriber database, subscriber data associated with a User Equipment, UE, of said SBA telecommunication network;
process equipment 406 arranged for determining, using memory 407, based on said subscriber data, that Quality of Service, QoS, differentiation is required for an application;
subscribe equipment 405 arranged for subscribing, to a Session Management Function, SMF, to reporting application detection information, wherein said subscribing indicates to said SMF that application detection information is to be reported by recognizing the occurrence of a value of a particular field in a certain protocol stack header of a packet different from previous values of said particular field in said protocol stack header of any packet received from said UE, said one particular field being comprised by a packet that is received by said UPF from a User Equipment, UE.

To reduce the number of claims, certain aspects of the technology are presented below in certain claim forms, but the applicant contemplates the various aspects of the technology in any number of claim forms. For example, while some aspect of the technology may be recited as a computer-readable medium claim, other aspects may likewise be embodied as a computer-readable medium claim, or in other forms, such as being embodied in a means-plus-function claim.

In the description above, for the purposes of explanation, numerous specific details are set forth in order to provide a thorough understanding of implementations of the disclosed technology. It will be apparent, however, to one skilled in the art that embodiments of the disclosed technology may be practiced without some of these specific details.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope thereof.

1.-32. (canceled)

33. A method of reporting application detection information by a User Plane Function, UPF, in a Service Based Architecture, SBA, telecommunication network, the method comprising:
receiving, by the UPF, from a User Equipment, UE, a packet associated with application traffic;
detecting, by the UPF, the application traffic;
determining, by the UPF, that application detection information is to be reported by recognizing the occurrence of a value of one particular field in a certain protocol stack header of the packet different from previous values of the particular field in the certain protocol stack header of any packet received from the UE, the one particular field being comprised by the packet; and
reporting, by the UPF, to a Session Management Function, SMF, the application detection information based on the determination that the application detection information is to be reported.

34. The method in accordance with claim 33, wherein the one particular field of the 5-tuple is the destination address.

35. The method in accordance with claim 33, further comprising:
receiving, by the UPF, a subscription to reporting application detection information, wherein the subscription indicates to the UPF that application detection information is to be reported by recognizing the occurrence of the value of the particular field in the certain protocol stack header of the packet different from previous values of the particular field in the protocol stack header of any packet received from the UE.

36. The method in accordance with claim 33, wherein the detecting the application traffic is based on per flow detection.

37. The method in accordance with claim 33, wherein the application detection information comprises the particular field and excludes the 5-tuple.

38. The method in accordance with claim 33, further comprising:
receiving, by the UPF, from the SMF, an Information Element, IE, associated with the application detection information, wherein the IE indicates that the application detection information is to comprise the particular field and is to exclude the 5-tuple.

39. The method in accordance with claim 33, further comprising:
maintaining, by the UPF, encountered values of the particular field.

40. The method in accordance with claim 33, wherein the maintaining comprises associating a time stamp for each of the encountered values, and wherein the method further comprises:
disregarding, by the UPF, an encountered value of the particular field when a timer, from the associated time stamp, has exceeded a predefined time period.

41. A method of supporting reporting application detection information by a Session Management Function, SMF, in a Service Based Architecture, SBA, telecommunication network, the method comprising:
subscribing, by a Session Management Function, SMF, comprised by the SBA telecommunication network, to a User Plane Function, UPF, to reporting application detection information, wherein the subscribing indicates to the UPF that application detection information is to be reported by recognizing the occurrence of a value of a particular field in a 5-tuple of a packet, the 5-tuple comprising source address, source port, destination address, destination port and protocol, different from previous values of the particular field in the 5-tuple of any packet received from the UE, the one particular field being comprised by a packet that is received by the UPF from a User Equipment, UE, such that application traffic is aggregating based on the one particular field of the 5-tuple.

42. The method in accordance with claim 41, wherein the one particular field is the destination address.

43. The method in accordance with claim 41, wherein the UPF is to detect a 5-tuple comprising source address, source port, destination address, destination port and protocol, and wherein the method further comprises:
transmitting, by the SMF, to the UPF, an Information Element, IE, associated with the application detection information, wherein the IE indicates that the application detection information is to comprise the particular information element and is to exclude the detected 5-tuple.

44. The method in accordance with claim 41, the method further comprises:
receiving, by the SMF, from the UPF a Policy and Charging Control, PCC, rule with Service Data Flow, SDF, filter comprising only the particular information element.

45. The method in accordance with claim 41, wherein the subscribing is implemented in a Packet Forwarding Control Protocol, PFCP, Session Establishment Request message.

46. A method of supporting reporting application detection information by a Policy Control Function, PCF, in a Service Based Architecture, SBA, telecommunication network, the method comprising:
retrieving, by the PCF, from a subscriber database, subscriber data associated with a User Equipment, UE, of the SBA telecommunication network;
determining, by the PCF, based on the subscriber data, that Quality of Service, QoS, differentiation is required for an application;
subscribing, by the PCF, to the SMF, to reporting application detection information, wherein the subscribing indicates to the SMF that application detection information is to be reported by recognizing the occurrence of a value of a particular field in a 5-tuple of a packet, the 5-tuple comprising source address, source port, destination address, destination port and protocol, different from previous values of the particular field in the 5-tuple of any packet received from the UE, the one particular field being comprised by a packet that is received by the UPF (201) from a User Equipment, UE, such that application traffic is aggregating based on the one particular field of the 5-tuple.

47. A User Plane Function, UPF, arranged for reporting application detection information in a Service Based Architecture, SBA, telecommunication network, the UPF comprising:
receive equipment configured to receive, from a User Equipment, UE, an Internet Protocol, IP, packet directed associated with application traffic;
detect equipment configured to detect the application traffic comprising detecting a 5-tuple, comprising source address, source port, destination address, destination port and protocol;
process equipment configured to determine that application detection information is to be reported by recognizing the occurrence of a value of one particular field in a the 5-tuple of the packet different from previous values of the particular field in the 5-tuple of any packet received from the UE, the one particular information element being comprised by the packet, such that the application traffic is aggregating based on the one particular field of the 5-tuple; and
report equipment configured to report to a Session Management Function, SMF, the application detection information based on the determination that the application detection information is to be reported.

48. The UPF in accordance with claim 47, wherein the one particular field of the 5-tuple is the destination address.

49. The UPF in accordance with claim 47, wherein the receive equipment is further configured to receive a subscription to reporting application detection information, wherein the subscription indicates to the UPF that application detection information is to be reported by recognizing the occurrence of the value of the particular field in the 5-tuple of the packet different from previous values of the particular field in the 5-tuple of any packet received from the UE.

50. The UPF in accordance with claim 47, wherein the detect equipment is further configured to detect the application traffic based on per flow detection.

51. The UPF in accordance with claim 47, wherein the receive equipment is further configured to receive, from the SMF, an Information Element, I E, associated with the application detection information, wherein the IE indicates that the application detection information is to comprise the particular field and is to exclude the 5-tuple.

52. The UPF in accordance with claim 51, wherein the application detection information comprises the particular information element and excludes the 5-tuple.
